(19) United States
(12) Patent Application Publication
(10) Pub. No.: US 2012/0130775 A1
(43) Pub. Date: May 24, 2012

(54) METHOD OF PROCESSING A TRANSACTION FOR A PARKING SESSION

(76) Inventors: ALBERT BOGAARD, ATLANTA, GA (US); Ivo Wentholt, 2596 CG, Wassenaarseweg 47,The Hague (NL); Jacek sadkowski, 4238 Riverview Drive, Duluth, GA (US)

(21) Appl. No.: 12/949,647

(22) Filed: Nov. 18, 2010

(51) Int. Cl. G07B 15/02

(52) U.S. Cl. 705/13; 705/418

(57) ABSTRACT

A method for processing a transaction for a parking session between a parking supplier and a payment provider on behalf of a user, wherein the user facilitates the transaction through a mobile computing device connected to a remote server, including, on the mobile computing device of the user, the steps of: storing a user identifier, first receiving a parking identifier, then sending the user identifier and the parking identifier to the server. The method also includes, on the server, the steps of: receiving the user identifier and the parking identifier, retrieving parking information based on the parking identifier; retrieving user information based on the user identifier, and processing a transaction between the payment provider and parking supplier, wherein the transaction amount is based on the duration of the parking session, wherein the parking session has a start time and an end time.

### TECHNICAL FIELD

This invention relates generally to the mobile parking payment field, and more specifically to an improved and useful method of processing a transaction for a parking session.

### BACKGROUND

In conventional systems of on-street parking, off-street parking (non-gated and gated), and controlled zoned parking, user payment for the use of parking spaces is required. Examples include street meters, parking lots and garages. Typically, these payments are limited to cash or coin payments. Unfortunately, many users oftentimes don't have the correct denomination of cash to pay for the parking session, or may consider the payment process too time-consuming (e.g. too much time waiting in line or looking for change), leading to noncompliance wherein the user simply does not pay for the use of the parking space. This noncompliance causes the parking suppliers to pay for more parking enforcement to cite the noncompliant users, which can be costly for the parking suppliers and inconvenient for the users. Additionally, because users must pay for the parking beforehand, users may pay for more parking than necessary, which is not cost efficient for the user. The conventional parking payment system is inefficient for the parking providers as well, as they need to pay for personnel to enforce parking payment. Additionally, keeping the parking payments “on street” (e.g. in pay boxes or meters) often leads to shrinkage and loss of revenue.

Conventional systems have tried to address these issues by offering prepay services, wherein the user pays in advance for an account from which parking payments are deducted as the user utilizes the parking spots. However, such prepay systems have several drawbacks. For example, these systems may be inconvenient because the user periodically needs to remember to refill the prepaid account, which may be a burdensome process. Additionally, the user may need to carry additional equipment, such as a card or device that allows them to pay for the parking.

Other conventional systems have attempted to address these issues by incorporating parking space identifiers in lieu of the parking meter, wherein users may remotely pay for the parking spot by using their mobile phone. For example, as described in U.S. Pub. No. 2006/0116892, which is hereby incorporated in its entirety by this reference, a placard or sign may be placed on the meter near the parking space with a phone number that the user may call. After the call is placed, the user may then enter a parking identifier into their phone and proceed to pay for the parking spot. These parking payment systems are time-consuming, as the user must take the time to place a call, wait for the call to be connected, then enter the parking information. Additionally, these systems may be costly for the user, as users may pay for each minute they are connected to a call; with these systems, not only does the user need to pay for the parking, but they must also pay for the minutes used during the call (and hope that they remain connected for the entirety of the phone call). Such parking payment systems may also require the refitting of the parking meters or payment kiosks to accept the payment, adding inconvenient capital equipment costs to the parking provider.

Thus, there is a need in the parking payment field to create an improved and useful method of processing a transaction for a parking session.

### BRIEF DESCRIPTION OF THE FIGURES

FIG. 1 is a schematic representation of the parking payment method.

FIG. 2 is a schematic representation of the functions of the mobile computing device.

FIG. 3 is a schematic representation of the functions of the server.

FIG. 4 is a schematic representation of the step of storing user information on the mobile computing device.

FIG. 5 is a schematic representation of the mobile computing device receiving a parking identifier.

FIG. 6 is a schematic representation of the mobile computing device sending information to the server and the server receiving the information.

FIG. 7 is a schematic representation of the server retrieving parking information and retrieving user information.

FIG. 8 is a schematic representation of meeting a start condition and meeting an end condition.

FIG. 9 is a schematic representation of processing a transaction between a payment provider and a parking supplier.

FIG. 10 is a schematic representation of receiving a vehicle identifier.

FIG. 11 is a schematic representation of receiving a parking location selection.

FIG. 12 is a schematic representation of receiving a parking duration selection.

FIG. 13 is a schematic representation of displaying an expiration notification on the mobile computing device.

FIG. 14 is a schematic representation of a first embodiment of the parking payment method.

FIG. 15 is a schematic representation of a second embodiment of the parking payment method.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

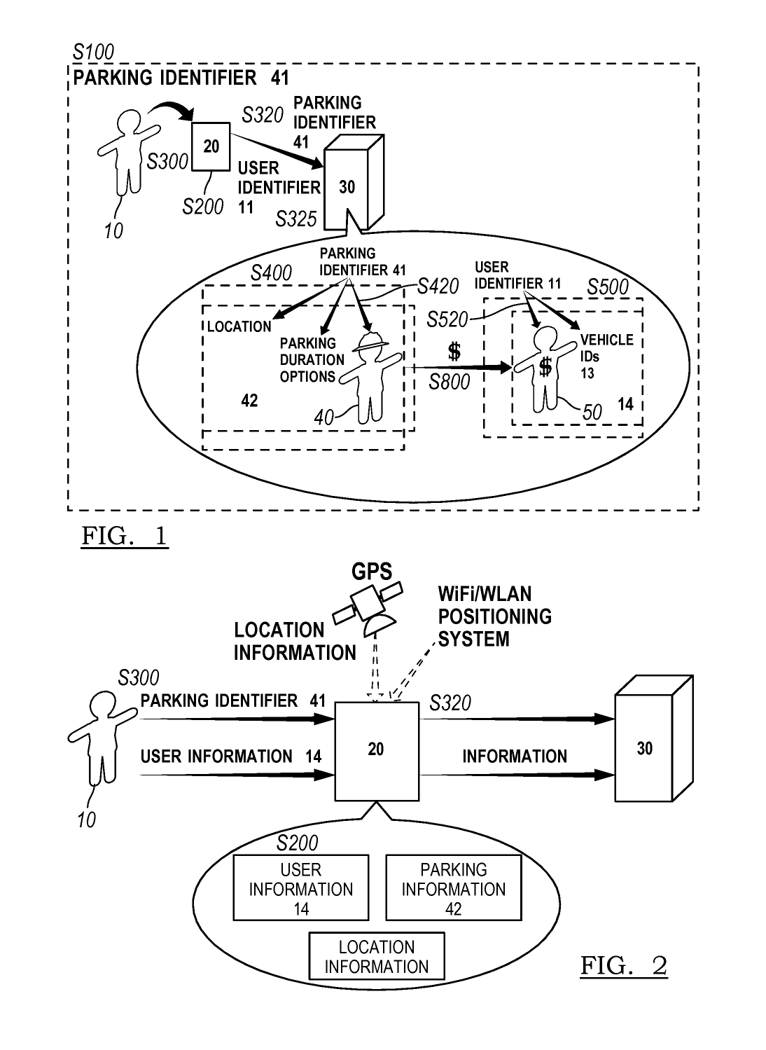

As shown in FIG. 1, the preferred embodiments of the invention include a method S100 of processing a transaction for a parking session between a parking supplier and a payment provider on behalf of a user 10, wherein the user 10 facilitates the transaction through a mobile computing device 20 connected to a remote server 30. The method S100 includes, on the mobile computing device 20 of the user 10, the steps of: storing a user identifier S200; first receiving a parking identifier S300, then sending the user identifier and the parking identifier to the server S320. The method S100 also includes, on the remote server 30, the steps of: receiving the user identifier and the parking identifier S325; retrieving parking information based on the parking identifier S400; retrieving user information based on the user identifier S500; and processing a transaction between the payment provider and parking supplier S800.

This method S100 is faster and more convenient than conventional methods for several reasons. First, this method S100 allows the parking transaction to be accomplished without an actual phone call, eliminating the costs and inconveniences associated with making a phone call. Second, most of the user-specific information 14 necessary for the user 10 to obtain parking (e.g. the user identifier 11 and/or vehicle identifier 13) may be stored on the mobile computing device 20, so the user 10 does not have to spend time re-entering the information each time they pay for parking. Third, because the majority of parking-relevant information (e.g. the user identifier 11 and/or parking identifier 41) is gathered before the mobile computing device 20 connects to the server 30, multiple pieces of information may be sent to the server 30 in substantially one step instead of sending single pieces of information in a series of substantially temporally distinct steps. Because multiple pieces of information may be sent in a set of data packets, this method S100 may additionally connect to the server 30 faster than prior art systems if the connection prioritizes data transfer over voice calls, which may be particularly pertinent if in an area with a lot of mobile device traffic (e.g. in San Francisco or a sold-out concert). Furthermore, because this method S100 only requires the mobile computing device 20 of the user, this method S100 may be less expensive for the user 10, as the user 10 needs only to pay for several packets of data instead of several minutes of a phone call, and does not need to purchase any additional equipment. This method S100 may be less expensive for parking suppliers 40 as well, because minimal parking infrastructure changes need to be implemented—instead of having to refit the parking areas with new parking equipment (e.g. parking meters or kiosks, as in conventional systems), the parking suppliers 40 may only need to add a parking identifier 41 to the existing equipment. Additionally, with this method S100, more users 10 may pay for parking because it is more convenient to do so. For example, this method S100 allows mass transit users to park, get on the train, bus, ferry, etc., then complete their parking transaction from their seat, allowing the users to successfully board the mass transit vehicle and still pay for parking. This method S100 also reduces the need for parking providers to pay for parking reinforcement and towing services. This method also allows parking providers to retain revenue and prevent shrinkage, as the payments are no longer kept “on-street.” The method S100 may also reduce transactional costs by lumping together transactions for multiple parking sessions, such that one authentication and transaction may be performed for several parking sessions at once instead of performing them for every parking session.

The entities that may be involved with the method include the users, the parking providers, and the payment providers. The users 10 are people who desire to leave a vehicle 12 in a parking space for a period of time. The vehicle 12 is preferably a car, but may alternatively be a bicycle, a motorcycle, a boat, or any suitable conveyance that is steered or operated by a person and transports items. The parking providers of this method S100 are preferably municipalities, but may alternatively be private operators, stadiums, event venues, universities, hospitals, airports, Mass Transit Authorities or any other entity that requests payment for parking. The payment providers 50 of this method S100 function to pay the parking fee on behalf of the user 10, and are preferably credit card companies, but may alternatively be a bank, an e-commerce payment service (e.g. PayPal), a mutual fund, or any other source of liquid assets with whom the user 10 has an account. The payment provider 50 may alternatively be a business entity affiliated with the user 10. The account the user 10 has with the payment provider 50 is preferably a credit account, but may alternatively be a debit account, a stored value account, or an online account.

The method is preferably used by the user 10 to pay for one or more parking sessions. The parking session is the duration of time that a user 10 leaves a vehicle 12 in a parking spot, and is characterized by a start time 72 and an end time 74, wherein the parking duration 70 is the amount of time elapsed between the start time 72 and the end time 74. The parking duration is preferably calculated as the difference between the start time and the end time, but may alternately be directly measured by a timer started at the start time and ended at the end time. The parking session (and therefore, the start and end times) is preferably recorded on the server 30, but may alternately be recorded on the mobile computing device 20. The start time 72 of the parking session is preferably determined from the time a start condition is met, and the end time 74 is preferably determined from the time an end condition is met. The start and end times are preferably time stamps, and preferably include the date, hour and minute of the start and end times. The parking session is preferably a start duration parking session, wherein the parking duration 70 of the parking session is preferably defined by the user 10 at the start time 72 (e.g. for metered parking or pre-paid street parking). A start duration parking session is analogous to metered parking, wherein the parking duration 70 in a specific parking spot is determined at the start of the parking session, and the user 10 pays for the desired parking duration at the onset of the parking action. The parking duration 70 of the start duration parking session may additionally be extended by additional time blocks up to a maximum parking duration (preferably set by the parking supplier 40). The parking session may alternatively be a start-stop parking session, wherein the parking duration is preferably undefined until the user 10 ends the parking session (e.g. airport parking, private parking lots). The start-stop parking session may also be subject to parking restrictions (e.g. the maximum parking duration is 3 hours), preferably set by the parking supplier, wherein the meeting of the parking restriction ends the parking session. A start-stop session parking session is analogous to airport parking, wherein there is no maximum parking duration (the user 10 may park as long as they wish), and the user 10 pays for the parking duration 70 after the parking session has been explicitly ended by the user 10, or a maximum parking time allowed set by supplier 40 is reached. The user 10 and parking supplier 40 are preferably allowed access to information about current and past parking sessions that they are affiliated with. For example, the user may check the parking duration on any of their current or past parking sessions, or the parking supplier may access the vehicle identifiers associated with their current parking sessions during parking enforcement.

As shown in FIG. 2, the mobile computing device 20 functions to provide an interface between the user 10 and the server 30 and, more specifically, to receive data from the user 10 and send the data to the server 30. The mobile computing device 20 may additionally function to store user information 14 received from the user 10 as well to gather user and location information. The mobile computing device 20 is preferably a smart phone (e.g. iPhone, Android, Blackberry, Windows Mobile or any other mobile computing technology platforms), but may alternately be a laptop, a tablet, or any suitable mobile computing device 20 that is capable of saving data, accessing data, and connecting to the server 30. The mobile computing device 20 may additionally include a camera, a barcode scanner, or a RF receiver. The mobile computing device 20 is preferably connected to the server 30 through telecommunication, more preferably through mobile wireless communication such as the services provided by Verizon, AT&T or Sprint (e.g. GSM or CMDA), but may alternately be any mobile wireless communication. The mobile computing device 20 may also connect to the server 30 through an internet service such as broadband, Wi-Fi, WiMax, LTE or any other internet computing technology, wherein the mobile computing device 20 preferably connects to the server 30 wirelessly, but may alternately be wired to the server 30. The mobile computing device 20 may also connect to the server 30 through a satellite connection, radio connection or any other connection that permits data transfer. The mobile computing device 20 may include multiple methods of connecting to the server, and may choose a preferred data transfer channel based on availability and actual signal strength and/or bandwidth availability. The interface provided by the mobile device is preferably a graphical user interface (GUI) with an application programming interface (API), but may alternatively be a web browser, a text box, or a button. User information 14 stored on the mobile computing device 20 may include the user identifier 11, a user password, vehicle identifiers 13 for the user's vehicles, payment provider information 52, or any other information that is associated with the user 10. Other information that may be stored on the mobile computing device 20 include parking information 42, wherein frequented parking identifiers 41 are stored, or the user's parking session history. The mobile computing device may additionally gather and store location information, wherein the location information is gathered by a global positioning system (GPS), a WiFi or WLAN positioning system (e.g. SkyHook technology) or a cellular tower positioning system, location images received from the user 10, or a location identifier (e.g. an address) received from the user 10.

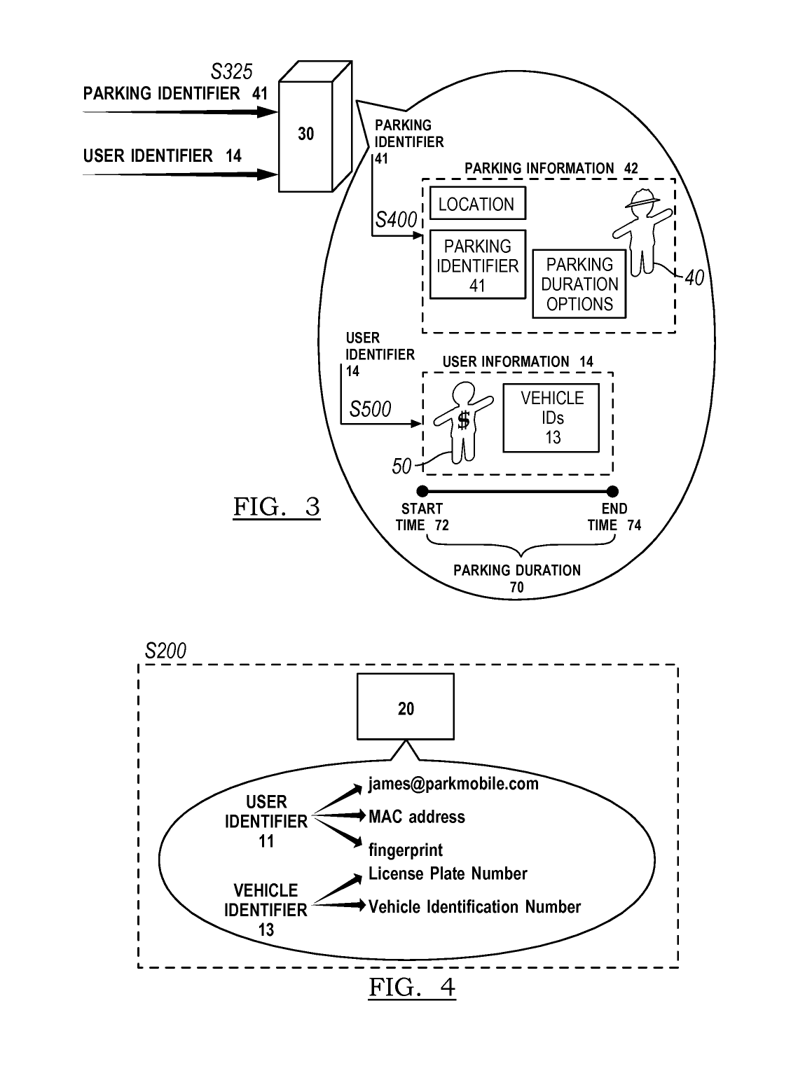

As shown in FIG. 3, the server 30 functions to receive data sent by the mobile computing device 20, to store user 10 and parking information 42, to validate received data against stored data, and to process transactions between the parking supplier 40 and payment provider 50. The server 30 may additionally function to store parking session data including the start time 72, the end time 74, the cost of the parking session, an identifier for the parking provider, and an identifier for the user 11 utilizing the parking session. The server 30 may additionally send data such as notifications or a list of options to the mobile computing device 20, or send data to the parking supplier 40 or payment provider 50. The server 30 may additionally be accessible by the user 10, parking supplier 40 or payment provider 50, wherein the aforementioned entities may access and edit the data within their respective accounts. The user information 14 stored by the server 30 includes the user identifier 11, the user's password, the user's payment provider account(s), one or more vehicle identifiers 13 associated with vehicle information, and a history of the user's prior parking sessions. The parking information 42 stored by the server 30 includes the parking supplier 40 identifier, a parking location, a parking space identifier (the parking identifier 41), parking options (type of parking, time tables and rates, such as, but not limited to: maximum parking time, parking duration options 45 available), pricing information, and a history of prior parking sessions associated with the parking space. The vehicle information stored by the server 30 may include the license plate number, the vehicle identification number (VIN), the registration number, a barcode, images of the vehicle identifier 13, a text description of the vehicle 12, or any other pieces of information that may uniquely identify the vehicle 12. Validation of data on the server 30 includes successfully retrieving associated user 10 or parking information 42 based on a provided user 10 or parking identifier 41. Validation may additionally include verifying the authenticity of the user 10 based on a received password or verifying the proximity of the user 10 to the identified parking space based on received location information.

As shown in FIG. 4, the step of storing a user identifier on the mobile computing device S200 functions to allow the mobile computing device 20 to access the user identifier 11 without the user 10 having to enter the user identifier 11 each time the method S100 is used. The user identifier 11 is preferably electronically stored in the memory located in the mobile computing device 20, and is preferably stored when the user 10 registers to use the system. The user identifier 11 functions to identify a user 10 of the system, and is associated with the user information 14 on the server 30. The user identifier 11 is unique to the user 10, and is preferably a username such as an email address or a user-generated alphanumeric code, but may an identifier unique to the mobile computing device 20 (e.g. the mobile computing device's MAC address, IMEI identifier, or serial number), the user's telephone number, a physiological biometric (e.g. an image of a fingerprint or an eye), or a vehicle identifier 13 identifier associated with the user 10. The user identifier 11 is preferably associated with a user-defined password, but may alternatively have no associated password.

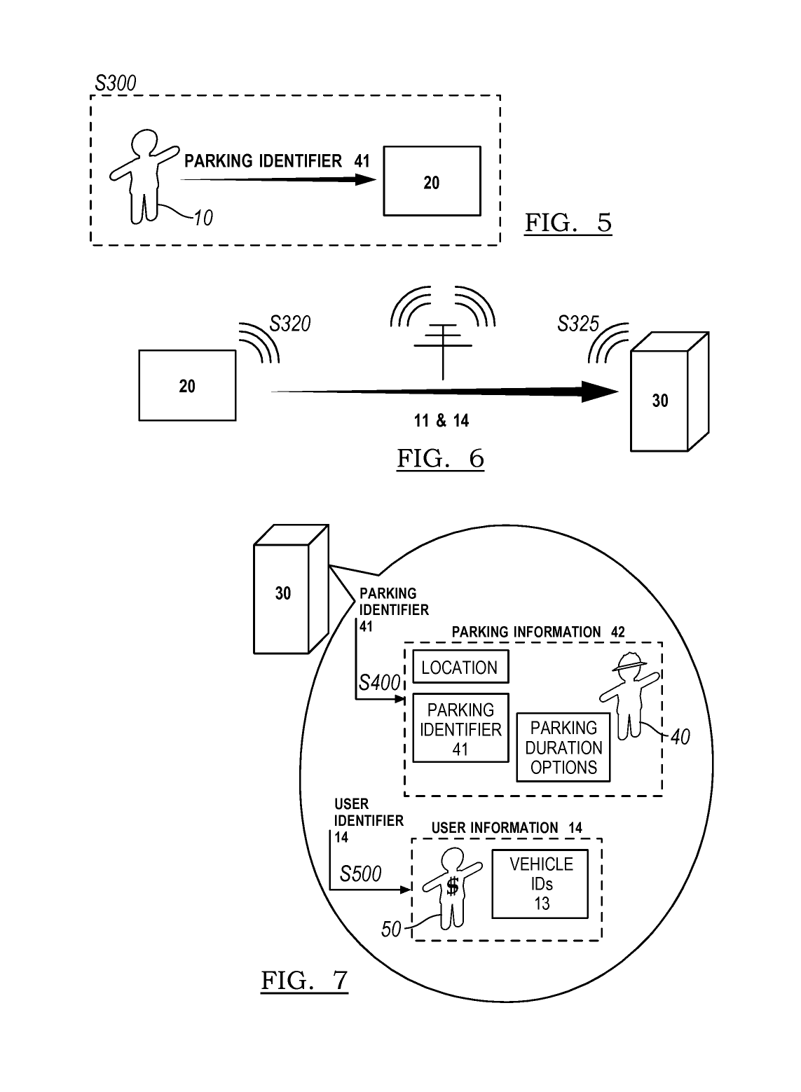

As shown in FIG. 5, the step of first receiving a parking identifier by the mobile computing device S300 functions to provide an identifier for the parking space in which the user 10 wishes to park to the system. The parking identifier 41 is preferably received by the mobile computing device 20 from user 10 input, but may alternatively be received through a wireless signal, such as a RF or Bluetooth. The user 10 preferably inputs the parking identifier 41 by typing it into the mobile computing device 20, but may alternately input the parking identifier 41 by taking a photo, scanning an image, prompting the mobile computing device 20 to gather location data, or speaking near the mobile computing device 20. The parking identifier 41 may alternately not be received from the user 10, but instead be generated by the mobile computing device 20 in response to a user action, for example in the case of pulling the user location with the API. The parking identifier 41 functions to identify the associated parking information 42 stored on the server 30, and is preferably received by the mobile computing device 20 from the user 10. The parking identifier 41 is preferably unique to the parking space, but may alternately be non-unique, wherein multiple parking spaces share the same parking identifier 41. In the latter case, the parking spaces are preferably located in different zones (e.g. one is in California while the other is in Arizona). The parking spaces are preferably parking spots large enough to fit substantially one vehicle 12 (e.g. a parking spot in metered parking), but may comprise of a zone containing multiple parking spots and capable of accommodating many vehicles 12 (e.g. a parking lot). The parking identifier 41 is preferably an alphanumeric code, but may alternatively be an image (e.g. a barcode or a QR code), data encoded in a wireless signal (e.g. RF signal, Bluetooth signal), or a location pulled by the API. The parking identifier 41 is preferably displayed on or near a parking space in the form of a sticker or a sign, but may alternatively be a signal transmitter located on or near the parking space or be the determined location of the parking space.

As shown in FIG. 6, the steps of then sending the user identifier and the parking identifier to the server by the mobile computing device S320 (and the corresponding step of receiving the user identifier and the parking identifier by the server S325) functions to provide user 10 and parking space-identifiers 41 to the server 30. This step occurs after the step of receiving the parking identifier by the mobile computing device S300. This step is preferably automatic, wherein reception of the parking identifier 41 by the mobile computing device 20 automatically prompts the mobile computing device 20 to send the user 10 and parking identifier 41 to the server 30. The identifiers are preferably sent via a data channel provided through a mobile communication network, but may alternately be sent through an internet provider, a radio channel, satellite or any other channel that allows for data transfer.

As shown in FIG. 7, the steps of retrieving parking information based on the parking identifier S400 and retrieving user information based on the user identifier S500, function to provide the necessary information for the processing of the transaction for the parking session. The user information 14 is preferably retrieved first to ensure that the method S100 is being performed for a registered user 10 of the system, but the parking information 42 may alternately be retrieved first. Successful retrieval of the information qualifies as verification of the identifiers. Both the user 10 and parking information 42 are preferably retrieved from the server 30 by searching the server 30 database for the user 10 and parking identifier 41s, then retrieving the information associated with the identifiers. User information 14 that is preferably retrieved includes vehicle information and the payment provider information 52, but other user-related information may additionally be retrieved, such as the type of user account (e.g. business vs. individual). The vehicle information is preferably retrieved because it is preferably associated with the parking session, such that parking enforcement may identify the user's vehicle 12. The payment provider information 52 is preferably retrieved because it is used to pay for the parking session. Parking information 42 that is preferably retrieved includes the parking duration options 45, pricing information, and parking supplier information 47, but may additionally include the location of the parking space, the demand for the parking space, or any other information associated with the parking space. Parking duration options preferably include the time blocks available for the user to pre-purchase (e.g. 15 min, 30 min, 1 hr), but may alternately or additionally include the time interval/unit increments that may be paid for (e.g. user must pay for every 15 minute increment) or any parking restrictions that may be set by the parking supplier (e.g. maximum parking time, times and days when parking is not allowable). Parking duration options 45 are preferably retrieved because different use cases of the method S100 may have different parking durations 70 available. For example, in a start duration session, the user 10 may park in the parking space for a limited time, and multiple time blocks (e.g. 15 minutes) up to a maximum session duration (e.g. 2 hours) are typically available to the user 10, wherein the parking duration 70 is the sum of time blocks selected by the user 10. In contrast, in a start-stop session (e.g. parking in an airport parking lot) wherein the user 10 may park in the parking space for as long as they wish, the parking duration 70 is determined from start time 72 and the end time 74 of the parking session.

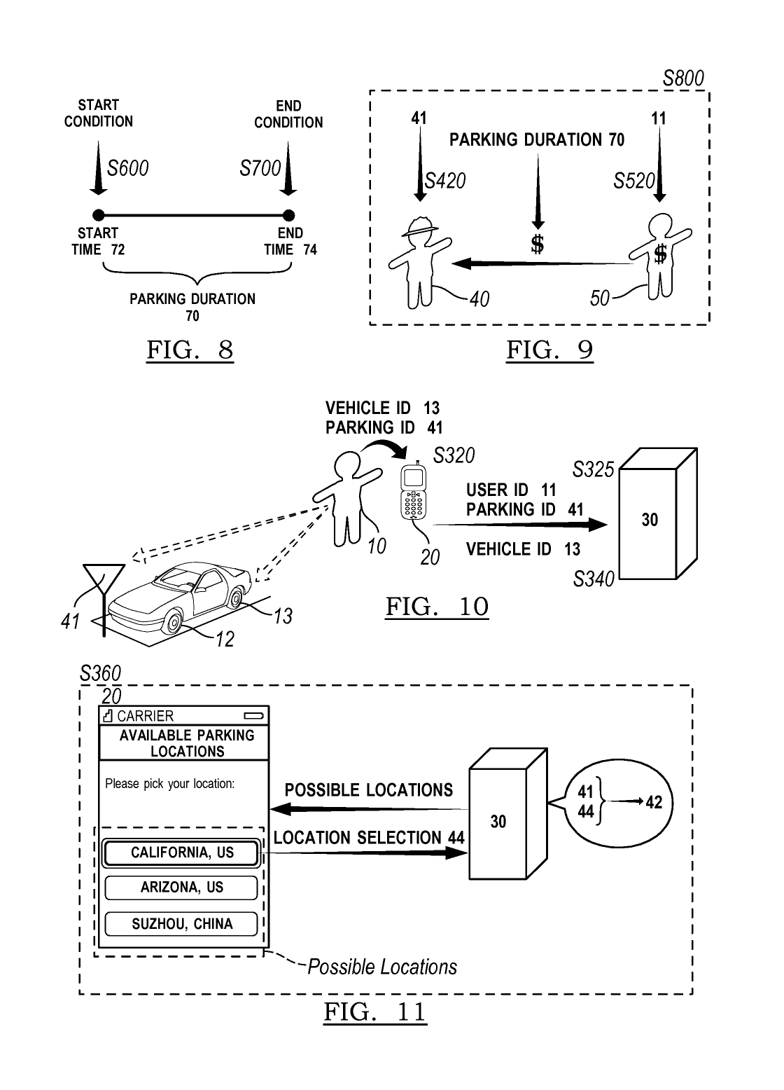

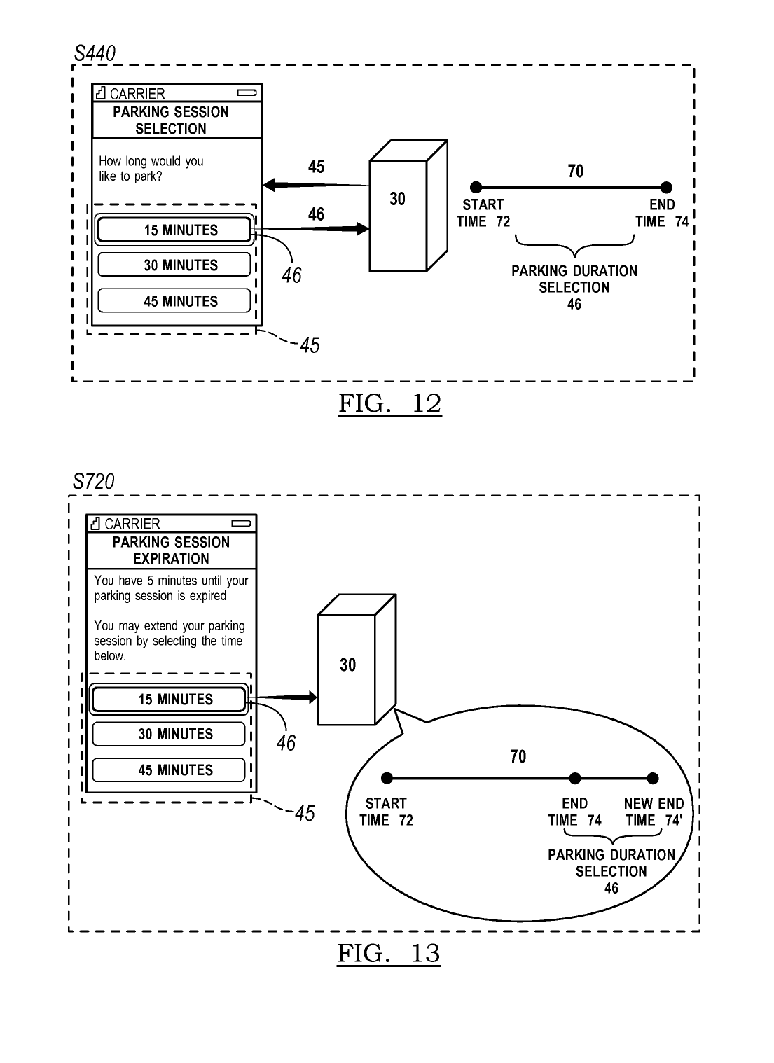

As shown in FIG. 8, the step of meeting a start condition S600 functions to notify the system that a parking session has commenced. The start condition is preferably the receipt of a start notification by the system from the user 10, wherein the start notification may be the selection of an option (e.g. selection of a “start parking” option or selection of a parking duration 70), the opening of an application, the receipt of a password, or any other notification indicating that a user 10 intends to start paying for parking. Alternately, the start condition may be the successful verification of the user identifier 11 and the parking identifier 41 by the server 30, wherein user information 14 is successfully retrieved using the user identifier 11, and unique parking information 42 is successfully retrieved using the parking identifier 41. The start condition is preferably the receipt of a start notification by the server 30, but may alternatively be the receipt of a start notification by the mobile computing device 20.

As shown in FIG. 8, the step of meeting an end condition S700 functions to notify the system that a parking session has ended. The end condition is preferably the receipt of an end notification by the server 30, wherein the end notification may be the selection of an option (e.g. selection of an “end parking” option), the closing of an application, the receipt of a password, or any other notification indicating that a user 10 intends to end payment for parking. In this case, the end notification is preferably first received by the mobile computing device 20 and sent to the server 30, wherein the end condition is the receipt of the end notification by the server 30. Alternately, the end condition may be the meeting of a predetermined time or timestamp (e.g. the time recorded by the timer matches a predetermined parking duration 70, or the current time matches the predetermined end time). In this case, the end condition may automatically met by the server 30, wherein the server 30 is recording and tracking the parking session, or an end notification may be automatically sent to the server 30 by the mobile computing device 20. Pricing information is preferably retrieved using the parking identifier 41 in order to calculate the transaction amount (the amount owed to the parking supplier 40). The parking supplier information 47 is preferably retrieved in order to record a parking session associated with the parking supplier 40 as well as to know whom to pay for the use of the parking space. The parking information 42 is preferably set by the parking supplier 40, but may alternately be dynamically computed by the server 30 based on time of day, demand, or any other factor.

As shown in FIG. 9, the step of processing a transaction between the payment provider and the parking supplier, wherein the transaction amount is based on the duration of the parking session S800, functions to pay the parking supplier 40 for the use of the parking space on behalf of the user 10. The payment provider 50 and parking supplier information 47 are preferably retrieved by the server 30 based on the user identifier 11 and parking identifier 41, respectively. The payment is preferably determined from the parking duration 70 of the parking session, but may alternatively be a flat fee. The payment transaction is preferably processed at the end of the parking session, but may alternatively be processed at the beginning of the parking session or periodically during the parking session (e.g. in the start duration or the start-stop parking sessions, where the parking durations 70 may be extended). Alternately, the payment amounts owed to different parking providers may be accrued on the server 30 until a specified time (e.g. the end of the day or the 15^{th} of the month), at which point one transaction with the total owed payment amount is processed, and a lump-sum payment is made by the payment provider 50 to the respective parking providers. The payment transaction is preferably processed by the server 30, but may alternately be processed by the mobile computing device 20.

As shown in FIG. 10, the method S100 may additionally include the steps of receiving a vehicle identifier by the server S340. This step functions to allow the system to associate a vehicle identifier 13 with the parking session, and allows the parking supplier 40 to identify the vehicle identifier 13 as associated with a user 10 that has paid for parking. This step is preferably used when the user 10 has more than one vehicle 12 associated with the user identifier 11, but may alternately be used when the user has only one vehicle 12 associated with the user identifier 11. The vehicle identifier 13 is preferably used by the server 30 to retrieve and verify the vehicle information after the user information 14 is retrieved. Alternately, the vehicle identifier 13 may be used to retrieve the user information 14, especially if the vehicle identifier 13 is only associated with one user identifier 11. The vehicle identifier 13 is preferably unique to each vehicle 12, and is preferably associated with one user 10, but may also be associated with two users 10, three users 10, or any number of users 10. The vehicle identifier 13 is preferably an alphanumeric code, such as a license plate number, but may alternatively be the VIN number, the registration number, an image (e.g. of the license plate, or a unique scratch on the vehicle 12), a barcode, or any unique identifier of the vehicle 12. The vehicle identifier 13 is preferably located on the vehicle 12 during the parking session. The vehicle identifier 13 is preferably visible, but may alternately be invisible but still be detectable (e.g. the vehicle identifier 13 is a wireless signal transmitted by the vehicle 12).

As shown in FIG. 2, the method S100 may additionally include the step of receiving location data by the server from the mobile computing device S360, which functions to identify the parking space. This step is preferably accomplished by the mobile computing device 20 gathering location data and sending the location data to the server 30. The location data is preferably gathered by a global positioning system (GPS) of the mobile computing device 20, but may alternately be gathered by a WiFi or WLAN positioning system (e.g. SkyHook technology) or a cellular tower positioning system. The server 30 preferably uses the location data to identify the parking space, wherein the location data is the parking identifier 41, but may alternately use the location data to verify the parking space, as in the case of non-unique parking identifiers 41 or just to verify that the user 10 has entered the parking identifier 41 of the parking space they are parked in. This step preferably occurs with the step of receiving the user and parking identifiers by the server 30.

As shown in FIGURE ii, the method S100 may additionally include the step of receiving a parking location selection by the server S360. This step is preferably used when the parking identifier 41 is non-unique to the parking space, and occurs when the server 30 is retrieving a unique set of parking information 42 based on the parking identifier 41. Due to the non-unique parking identifier 41, the server 30 will initially retrieve more than one set of parking information 42 associated with the parking identifier 41 after the parking identifier 41 is received by the server 30. In order to determine which unique parking space is being referenced (and subsequently, who to pay), the server 30 generates a set of possible locations by retrieving the location information from each of the parking information 42 sets and sending the set of possible locations to the mobile computing device 20, which displays the possible locations. The possible locations are preferably displayed as a list, but may be displayed as icons, a map, or any type of display that allows for a location selection 44. The possible locations are preferably substantially spatially separated, such as different countries, states, cities, or districts, but may be located substantially close to each other, such as two parking spots in the same parking lot. Upon the receipt of a location selection 44 from the user 10, the mobile computing device 20 sends the location selection 44 to the server 30, which retrieves a unique set of parking information 42 based on the parking identifier 41 and the location selection 44.

As shown in FIG. 12, the method S100 may additionally include the step of receiving a parking duration selection by the server S440. This step preferably occurs after the user 10 and parking identifiers are verified, but before the parking session is begun. This step is preferably used when the parking session is a start duration session, (e.g. metered parking, pre-paid off-street parking) wherein a user selection of a parking duration 70 option (i.e. a time block, e.g. 15 minutes) is needed because the parking provider requires pre-payment for the parking duration 70. This step preferably comprises the steps of the server 30 retrieving the parking duration options 45 from the stored parking information 42 and sending the parking duration options 45 to the mobile computing device 20, wherein the mobile computing device 20: receives the parking duration options 45, displays the options, receives a parking duration selection 46, and sends the parking duration selection 46 to the server 30. The parking duration options 45 are preferably displayed as a list by the mobile computing device 20, but may alternately be icons, a timeline, or any type of display that allows for a parking duration selection 46. The parking duration options may alternately not be displayed, but be received from displayed entry fields that allow the user 10 to enter a desired amount of parking time (e.g. 5 min, 23 min, or one hour), wherein the entered parking time is less than the maximum parking time allowed for the parking identifier 41. The server 30 then sets an end time for the parking session based on the start time 72 and the parking duration selection 46, wherein the meeting of the end time is the end condition.

As shown in FIG. 13, the method S100 may additionally include the step of displaying an expiration notification on the mobile computing device S720, which functions to notify the user 10 of the imminent end of the parking session. The expiration notification is preferably sent near but before the end of the parking session, but may alternately be sent near the start of the parking session or anytime during the parking session. The expiration notification is preferably sent by the server 30 and received by the mobile computing device 20, but may alternately be generated by the mobile computing device 20. The expiration notification is preferably an SMS, but may alternately be a push notification, a MMS, email, or any type of notification that may be displayed on a mobile computing device 20. The expiration notification preferably informs the user 10 of the amount of time left to the parking session, but may alternately simply notify the user 10 that the parking session has almost or already ended. The expiration notification may additionally include parking duration extension options 45, wherein the user 10 may select a parking duration 70 extension to extend their parking duration 70. In this case, the mobile computing device 20 receives the parking duration extension selection 46 and the parking duration 70 is extended by the parking duration extension selection 46, either by the server 30 or the mobile computing device 20. This step is preferably used when the step of displaying the parking duration options 45 on the mobile computing device 20 is used.

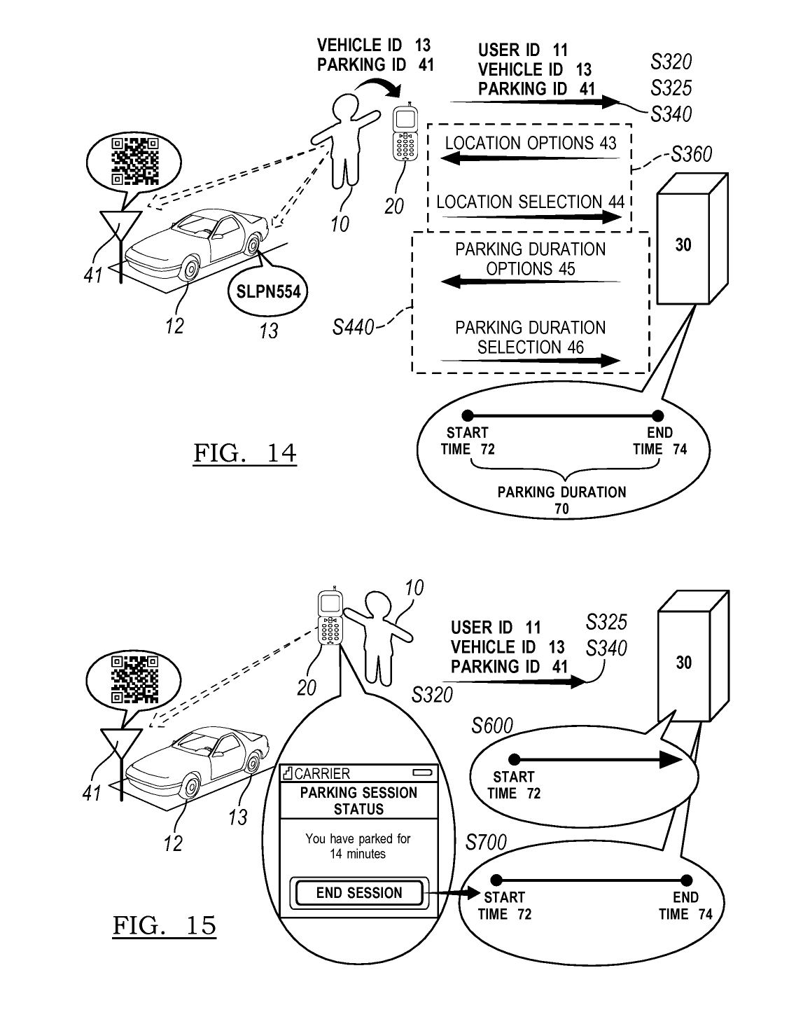

FIG. 14 shows a first exemplary implementation of the method S100, wherein the user 10 has multiple vehicles, the parking identifier 41 is a non-unique alphanumeric or numeric code posted on a meter, and the parking duration options 45 for the parking space is that of the start duration session, including any number of pre-paid time blocks (e.g. 15 min) up to a maximum parking time (e.g. 2 hours). Additionally, the start condition is the receipt of a parking duration selection 46 by the server 30, the end condition is the expiration of the parking duration 70, and the payment transaction is processed as soon as the parking duration selection 46 is made. Due to the multiple vehicles associated with the user 10, the step of receiving a vehicle identifier by the server S340 is used, wherein the vehicle identifier 13 is the license plate number. Due to the non-unique parking identifier 41, the step of receiving a parking location selection by the server S360 is used, wherein the parking spaces are located in two different cities, so the parking location options are those two cities. Due to the multiple parking duration options 45 available for the parking space, the step of receiving a parking duration selection by the server S440 is used, wherein the mobile computing device 20 displays the parking duration options 45 as a list. Upon the receipt of the parking duration selection 46, the start condition is met and the parking session is started, wherein the server 30 records a start time 72 and an end time 74, wherein the end time 74 is determined from the start time 72 and the parking duration selection 46. Because the parking duration 70 is known, the server 30 processes the payment transaction after the start of the parking session. In a variation of this exemplary implementation, the method S100 incorporates the step of displaying an expiration notification on the mobile computing device S720. The expiration notification is a notification generated by the mobile computing device 20, and includes parking duration options 45 available to the user 10 to extend their parking session.

FIG. 15 shows a second exemplary implementation of the payment method S100, wherein the parking identifier 41 is a QR code painted near the parking space, and the parking duration 70 is that of a start-stop session, wherein the parking option allows the user 10 to park for any amount of time up to the maximum parking duration set by the parking supplier 40. Additionally, the start condition is the verification of the user 10 and parking information 42, the end condition is the receipt of an end notification, generated from the user 10. The payment transaction is processed after the end notification is received. In this exemplary implementation, the mobile computing device 20 includes a camera, which is used by the user 10 to take a photo of the QR code, and a barcode/QR code decoder, which decodes the QR code image and extracts the embedded information. The information contained in the QR code prompts the mobile computing device 20 to send a unique parking identifier 41, contained in the QR code information, along with the saved user identifier 11 to the server 30. Upon receiving the user and parking identifiers (11 and 41, respectively), the server 30 verifies the identifiers and starts a parking session by recording a start timestamp. Throughout the duration of the parking session (before the end condition is met), the mobile computing device 20 is capable of displaying an “end session” option, wherein the “end session” option presents the user 10 with the option of ending the parking session. Upon receipt of the selection of the “end session” option, the mobile computing device 20 sends an end notification to the server 30, wherein, upon receipt of the end notification, the server 30 ends the parking session, computes the parking duration 70 from the start time 72 and the time the end notification was received, and processes a transaction between the payment provider 50 and parking supplier 40 based on the calculated parking duration 70 and pricing information.

As a person skilled in the art will recognize from the previous detailed description and from the figures and claims, modifications and changes can be made to the preferred embodiments of the invention without departing from the scope of this invention defined in the following claims.

1. A method of processing a transaction for a parking session between a parking supplier and a payment provider on behalf of a user, wherein the user facilitates the transaction through a mobile computing device connected to a remote server, the method comprising:
on the mobile computing device of the user,
storing a user identifier;
first receiving a parking identifier, then sending the user identifier and the parking identifier to the server;
on the server,
receiving the user identifier and the parking identifier;
retrieving parking supplier information based on the parking identifier;
retrieving payment provider information based on the user identifier;
processing a transaction between the payment provider and parking supplier, wherein the transaction amount is based on the duration of the parking session;
wherein the parking session has a start time and an end time, wherein the start time is determined from the time a start condition is met, the end time is determined from the time an end condition is met, and the parking session duration is the difference between the end time and start time.

2. The method of claim 1, wherein a vehicle identifier is further stored on the mobile computing device, and is sent with the user identifier and parking identifier to the server.

3. The method of claim 2, wherein the vehicle identifier is a license plate number.

4. The method of claim 1, wherein the parking identifier is an alphanumeric or numeric code.

5. The method of claim 1, wherein the start condition is the verification of the user identifier and the parking identifier, wherein verification comprises of successfully retrieving user information and parking information based on the user identifier and parking identifier, respectively.

6. The method of claim 5, wherein location information gathered by the mobile computing device is sent with the user identifier and parking identifier to the server, wherein the location information is additionally used to verify that the user is physically disposed near the parking identifier when the location information, user identifier, and parking identifier were sent to the server.

7. The method of claim 1, wherein the end condition is the receipt of an end notification by the server.

8. The method of claim 7, wherein the end notification is first received by the mobile computing device from the user, then sent by the mobile computing device to the server.

9. The method of claim 8, wherein the transaction IS processed after the end condition is met.

10. The method of claim 9, wherein the end notification is automatically sent to the server by the mobile computing device at the end time, wherein the end time is determined at the start time of the parking session.

11. The method of claim 1 further comprising retrieving parking information based on the parking supplier information by the server and sending the parking information to the mobile computing device.

12. The method of claim 11, wherein the parking information comprises of a list of parking locations available to the user.

13. The method of claim 11, wherein the parking information comprises of parking duration options available to the user.

14. The method of claim 13, wherein the start condition is the receipt of a parking duration selection by the server, wherein the parking duration selection is one of the parking duration options, and wherein the end condition is the meeting of the end time, wherein the end time is determined from the start time and the parking duration selection.

15. The method of claim 14, wherein the transaction is processed at the start time.

16. The method of claim 14, wherein an expiration notification is displayed on the mobile computing device before the end time.

17. The method of claim 16, wherein the expiration notification includes an option of extending the parking session duration, wherein upon reception of the selection of the option, the parking session duration is extended.

18. The method of claim 16, wherein the expiration notification is sent from the server to the mobile computing device, and wherein the expiration notification is a text message.

19. The method of claim 1 further comprising gathering location data on the mobile computing device and sending the location data from the mobile computing device to the server.

20. The method of claim 19, wherein the server retrieves parking information based on the location information.

21. The method of claim 19, wherein the location information is gathered by a global positioning system (GPS) of the mobile computing device.

22. The method of claim 4, wherein first receiving the parking identifier comprises:
receiving the alphanumeric or numeric code over a wireless signal.

23. The method of claim 4, wherein first receiving the parking identifier comprises:
capturing the alphanumeric or numeric code in a photograph.

24. The method of claim 4, wherein first receiving the parking identifier comprises:
scanning the alphanumeric or numeric code.

25. The method of claim 1, wherein the parking identifier is an encoded image.

26. The method of claim 25, wherein first receiving the parking identifier comprises:
capturing the encoded image in a photograph.

27. The method of claim 25, wherein first receiving the parking identifier comprises:
scanning the encoded image.

28. The method of claim 25, wherein the encoded image is a QR code.

29. The method of claim 25, wherein the encoded image is a bar code.

30. The method of claim 1, wherein the parking identifier identifies the parking supplier.

31. The method of claim 30, wherein the parking identifier identifies a parking location.

32. The method of claim 31, wherein the parking identifier identifies one of a plurality of parking spaces.

33. A method, using a mobile device, of initiating the processing of a transaction for a parking session between a parking supplier and a payment provider on behalf of a user, the method comprising:
storing a user identifier in memory on the mobile device;
receiving a parking identifier; and
transmitting the user identifier and the parking identifier to a network server.

34. The method of claim 33, wherein the parking identifier is an encoded image.

35. The method of claim 34, wherein the encoded image is a QR code.

36. The method of claim 34, wherein the encoded image is a bar code.

37. The method of claim 34, wherein receiving the parking identifier comprises:
capturing the encoded image in a photograph.

38. The method of claim 34, wherein receiving the parking identifier comprises:
scanning the encoded image.

39. The method of claim 33, wherein the parking identifier is an alphanumeric or numeric code.

40. The method of claim 39, wherein receiving the parking identifier comprises:
capturing the alphanumeric or numeric code in a photograph.

41. The method of claim 39, wherein receiving the parking identifier comprises:
scanning the alphanumeric or numeric code.

42. The method of claim 33, wherein the parking identifier identifies the parking supplier.

43. The method of claim 42, wherein the parking identifier identifies a parking location.

44. The method of claim 43, wherein the parking identifier identifies one of a plurality of parking spaces.

45. The method of claim 33, wherein the transaction amount is based on the duration of the parking session.

46. The method of claim 45, wherein the parking session has a start time and an end time, wherein the start time is determined from the time a start condition is met, the end time is determined from the time an end condition is met, and the parking session duration is the difference between the end time and start time.

47. A method of processing a transaction for a parking session between a parking supplier and a payment provider on behalf of a user, the method comprising:
receiving a user identifier and a parking identifier from a mobile device;
retrieving parking supplier information based on the parking identifier;
retrieving payment provider information based on the user identifier; and
processing a transaction between the payment provider and the parking supplier.

48. The method of claim 47, wherein the transaction amount is based on the duration of the parking session.

49. The method of claim 48, and wherein the parking session has a start time and an end time, wherein the start time is determined from the time a start condition is met, the end time is determined from the time an end condition is met, and the parking session duration is the difference between the end time and start time.

50. The method of claim 47, wherein the parking identifier is an encoded image.

51. The method of claim 50, wherein the encoded image is a QR code.

52. The method of claim 50, wherein the encoded image is a bar code.

53. The method of claim 50, wherein receiving the parking identifier from the mobile device comprises:
receiving the encoded image in the form of a photograph.

54. The method of claim 47, wherein the parking identifier is an alphanumeric or numeric code.

55. The method of claim 54, wherein receiving the parking identifier from the mobile device comprises:
receiving the alphanumeric or numeric code in the form of a photograph.

56. The method of claim 47, wherein the parking identifier identifies the parking supplier.

57. The method of claim 56, wherein the parking identifier identifies a parking location.

58. The method of claim 57, wherein the parking identifier identifies one of a plurality of parking spaces.
